(19) United States
(12) Patent Application Publication
(10) Pub. No.: US 2009/0104448 A1
(43) Pub. Date: Apr. 23, 2009

(54) PREFORMED ADHESIVE BODIES USEFUL FOR JOINING SUBSTRATES

(75) Inventors: James E. Thompson, Plymouth, MI (US); Grady C. Rorie, Ann Arbor, MI (US); Tanya Estrin, Novi, MI (US); Gregory A. Ferguson, Harrison Township, MI (US)

Correspondence Address: HENKEL CORPORATION, 1001 TROUT BROOK CROSSING, ROCKY HILL, CT, 06067, US

(73) Assignee: Henkel AG & Co. KGaA, Duesseldorf (DE)

(21) Appl. No.: 12/186,748

(22) Filed: Aug. 6, 2008

Related U.S. Application Data
(60) Provisional application No. 60/999,348, filed on Oct. 17, 2007.

(51) Int. Cl. B32B 37/02; B32B 27/38

(52) U.S. Cl. 428/413; 156/273.5; 156/230

(57) ABSTRACT

A first substrate may be joined to a second substrate using an adhesive body. The adhesive body is formed from an adhesive composition containing at least one epoxy resin, at least one heat-activatable curing agent, and at least one radiation-curable compound. A first surface of the adhesive body is exposed to an amount of radiation effective to cure at least a portion of the at least one radiation-curable compound present in proximity to such first surface, thereby rendering said first surface less tacky and/or more resistant to deformation. A second surface of the adhesive body is then applied to a surface of said first substrate. A surface of the second substrate is thereafter positioned proximate to or in contact with the first surface of the adhesive body and the adhesive body heated to a temperature effective to activate the heat-activated curing agent and induce curing of the at least one epoxy resin.

### CROSS-REFERENCE TO RELATED APPLICATION

This application claims priority to U.S. provisional application No. 60/999,348, filed 17 Oct. 2007, the disclosure of which is incorporated herein by reference in its entirety.

### FIELD OF THE INVENTION

The invention relates to the use of a preformed adhesive body in bonding together a plurality of substrates, where the preformed adhesive body contains epoxy resin, radiation curable compound(s) and heat-activatable curing agent(s) and has a surface which has been irradiated to render the surface less tacky and/or more resistant to deformation by irradiation.

### DISCUSSION OF THE RELATED ART

Many different types of structural adhesives are known and currently used in a variety of industrial applications. For example, one component structural adhesives may be formulated using epoxy resins and latent, heat activatable curing agents that are applied as liquids to substrate surfaces, then activated by heating to effect curing of the epoxy resin and the formation of a strong adhesive bond between different substrates. However, the handling and dispensing of such structural adhesives can be messy and require specialized, expensive equipment. The development of structural adhesives that can be more easily applied and used thus would be of great interest.

### BRIEF SUMMARY OF THE INVENTION

The present invention provides a method of joining a first substrate with a second substrate, said method comprising:
a). providing an adhesive composition comprised of at least one epoxy resin, at least one heat-activatable curing agent, and at least one radiation-curable compound;
b). forming said adhesive composition into an adhesive body having a preselected shape, said preselected shape having at least a first surface and a second surface;
c). exposing said first surface to an amount of radiation effective to cure at least a portion of the at least one radiation-curable compound present in proximity to said first surface, thereby rendering said first surface less tacky and/or more resistant to deformation (including tearing or breaking);
d). applying the second surface of the adhesive body to a surface of said first substrate;
e). positioning a surface of said second substrate proximate to or in contact with said first surface of said adhesive body; and
f). heating said adhesive body to a temperature effective to activate said heat-activated curing agent and induce curing of said at least one epoxy resin.

Even though the first surface of the adhesive body has been at least partially cured by exposure to radiation, it remains capable of forming a strong adhesive bond to the second substrate surface following heat activation of the curing agent. This result was surprising, since altering the surface characteristics of the adhesive body by reducing its tackiness would have been expected to significantly interfere with the adherence of such adhesive body to a substrate brought into contact with the irradiated adhesive body surface. The invention thus provides for the preparation of an adhesive body such as a tape having good inherent strength prior to heat activation/curing (thereby avoiding the need to support the adhesive body on a carrier film or the like prior to applying the adhesive body to a substrate), with one side being sufficiently tacky to permit it to be positioned onto a substrate surface by application of pressure and an opposite, outwardly facing side being reduced in tackiness and thus easily handled.

The invention further provides a method of making an adhesive body, said method comprising:
a). providing an adhesive composition comprised of at least one epoxy resin, at least one heat-activatable curing agent, and at least one radiation-curable compound;
b). forming said adhesive composition into an adhesive body having a preselected shape, said preselected shape having at least a first surface and a second surface, wherein said second surface is in contact with a protective sheet; and
c). exposing said first surface to an amount of radiation effective to cure at least a portion of the at least one radiation-curable compound present in proximity to said first surface, thereby rendering said first surface less tacky and/or more resistant to deformation.

An article comprising an adhesive body in combination with a protective sheet is additionally provided by the present invention, wherein a). said adhesive body has a preselected shape and is comprised of at least one epoxy resin, at least one heat-activatable curing agent, and at least one radiation-curable compound, said preselected shape having at least a first surface and a second surface, b). said second surface is in contact with said protective sheet; and c). at least a portion of said first surface has been exposed to an amount of radiation effective to at least partially cure said at least one radiation-curable compound in the region of said adhesive body proximate to said first surface.

### DETAILED DESCRIPTION OF CERTAIN EMBODIMENTS OF THE INVENTION

The present invention involves the use of an adhesive body to join a plurality of substrates together. The adhesive body is prepared using an adhesive composition comprised of at least one epoxy resin, at least one heat-activatable curing agent, and at least one radiation-curable compound. The adhesive composition is formulated such that it can be readily formed into a desired shape such as a relatively thin, flat sheet, tape, ribbon, or strip, or a bead, rod, rope or block or other three dimensional object. For example, the adhesive composition can be thermoplastic, at least up to a certain temperature, such that it can be heated and shaped by, for example, extrusion through a die or by molding (e.g., injection molding). The adhesive composition is also capable of being at least partially cured by irradiation. At least one surface of the adhesive body, such as the surface that ultimately is to be positioned facing away from the substrate surface to which the adhesive body is to be initially applied, is exposed to an amount of radiation (such as ultraviolet light or electron beam radiation) effective to achieve the desired extent of curing (crosslinking) of the adhesive composition on the selected surface of the adhesive body. The selected surface is thereby rendered more resistant towards being deformed by external forces such as manual manipulation and/or less tacky. The strength of the adhesive body is also enhanced by the irradiation, making the adhesive body more resistant to tearing or breaking when handled. In certain embodiments, the adhesive composition is cured sufficiently to make the selected surface of the adhesive body tack-free (non-tacky). At the same time, however, the irradiation is controlled such that the surface of the adhesive body that is to be initially applied to the substrate surface can retain sufficient tackiness and/or deformability such that said surface can adhere and/or closely conform to the substrate surface when pressed into placed against said substrate surface. The tacky surface can be temporarily protected against contamination and prevented from prematurely adhering to undesired surfaces (such as a worker's fingers or other adhesive bodies, where the adhesive bodies are stacked together prior to use) by means of a protective sheet such as a release film or release paper that is capable of being peeled from such tacky surface. An adhesive body prepared in accordance with the foregoing procedure thus can be readily handled and applied where desired to a substrate surface. Curing a surface of the adhesive body using radiation provides the additional advantage that the less cured or uncured adhesive composition in the remainder of the adhesive body can remain thermoplastic and capable of flowing when heated, but the flow of the adhesive composition is restricted or constrained by the radiation-cured surface, which exhibits less flow when heated. This feature enables the formation of the adhesive bond between substrates to be controlled, reducing dripping or running of the adhesive composition and spread of the adhesive composition to areas of the substrate surface where adhesive is not desired. The present invention does not require co-extrusion or lamination steps in the assembly of the adhesive body and thus represents an advance over known adhesive bodies incorporating dimensionally stable carrier films or barrier portions, the manufacture of which can be complicated.

The irradiation step can be controlled such that at least one other surface of the adhesive body (such as the surface that ultimately is to be brought into contact with a first substrate surface) remains deformable and therefore capable of being brought into close conformance with the substrate surface, thereby facilitating initial positioning of the adhesive body and promoting strong adhesion of the adhesive body to such substrate surface following heat curing. In one aspect of the invention, the adhesive composition proximate to such other surface remains flowable when heated. Thus, when the adhesive body is placed over the substrate and heated, the surface of the adhesive body applied to the substrate surface softens and bonds to the substrate (such surface thereby functions like a hot melt adhesive), with the adhesive composition resolidifying when cooled to room temperature. The adhesive composition is capable of being thermally cured by incorporating one or more heat-activated curing or crosslinking agents which, once activated by heating to an elevated temperature, react with and/or catalyze reaction of other components of the adhesive composition, thereby forming a thermoset polymeric matrix which is resistant to further deformation. In one particularly desirable variation of the invention, the adhesive composition is formulated so that it remains sufficiently thermoplastic to permit the adhesive composition to flow when heated up to a certain temperature or for a certain limited period of time, but then undergo crosslinking/curing when heated to a higher temperature or for a longer period of time. In still another embodiment, the components of the adhesive composition are selected to render a non-radiation cured surface of the composition sufficiently tacky at room temperature such that the surface adheres to the substrate surface by application of pressure to the adhesive body. In this embodiment, the adhesive composition thus functions as a pressure-sensitive adhesive.

The present invention may be used in a number of industrial applications. For example, the adhesive body can be utilized in a process to join metal parts in automobiles.

In one embodiment of the invention, the surface of the adhesive body that is to be applied to a first substrate surface is tacky or pressure sensitive and is initially protected by a temporary substrate such as a disposable liner or release paper (e.g., silicone-coated paper). Such a temporary substrate blocks dirt and other substances from contaminating the adhesive body surface and interfering with adhesion of the adhesive body to the substrate surface. Additionally, a temporary substrate may facilitate storage and handling of the adhesive body (for example, the adhesive body could be in the form of a tape that is wound upon itself or a sheet that is stacked upon other sheets with the temporary substrate inbetween). Before applying the adhesive body to the first substrate surface, the temporary substrate is removed to expose the adhesive body surface to be contacted with the substrate surface.

Although the adhesive body may be formed in a variety of shapes or configurations, in one embodiment the adhesive body is shaped as a sheet or elongated strip that extends along a length L and that has a generally rectangular cross-section perpendicular to that length L. The adhesive body thus may have a first substantially flat side (which may be the side which will be surface-cured using radiation and which ultimately will be the exterior or outwardly facing side once the adhesive body is applied to a first substrate surface) and a second substantially flat side (which may be the side which ultimately will be one of the sides applied against the first substrate surface), with the first side and second side being separated by a thickness T and being substantially parallel to each other. The adhesive body may contain one or more openings, but in other embodiments is continuous and free of any openings.

In one specific embodiment, the adhesive body is cut or otherwise formed into a strip having a width and a length approximately equal to the width and length desired for the adhesive bond between a first substrate and a second substrate. The adhesive body is placed on the surface of the first substrate; typically, pressure is applied so as to bring the non-radiation cured surface of the adhesive body into at least partial contact with the substrate surface. The substrate surface preferably is metal, which may be unprimed, unprimed with a portion sealed with conventional sealers, primed with conventional primers, or primed and painted.

The adhesive bodies of the present invention are especially useful in the assembly of vehicles, where components of a vehicle are to be joined together utilizing the adhesive body or a plurality of adhesive bodies. The vehicle, with the adhesive body in place, may be painted (including optionally also a protective clear coat) and put through an oven cure cycle at about 120 to about 200 degrees C. for about 10 to about 60 minutes. The adhesive body may be formulated so that the epoxy resin that is present is thermally cured through activation of curing agents/catalysts during such oven cure cycle.

The adhesive composition may be formed into the desired adhesive body shape such as a sheet using conventional forming techniques, including extruding the adhesive composition through a heated die; molding the adhesive composition while heated in a mold of the desired configuration; heating the adhesive composition to a suitable melt/softening temperature and knife coating onto a release liner; curtain coating the adhesive composition while molten/softened; or dispersing the adhesive composition in a solvent, coating onto a release liner, and drying the solvent. If the forming method selected involves heating and the adhesive composition contains a latent (heat activated) curing agent or catalyst, care should be taken to keep the temperature of the adhesive composition below the minimum temperature at which the curing agent or catalyst will significantly crosslink or cure the adhesive composition. Once formed into a sheet, the adhesive composition can be further processed to provide the adhesive body of the desired dimensions, such as by die cutting or slitting the sheet. Alternatively, the adhesive composition can be directly shaped into the desired form for placement on a substrate surface.

The thickness of the adhesive body will vary depending upon its intended end use. For most sealing applications, it is desirable to have the adhesive body thick enough to provide sufficient material to provide an adhesive bond of the desired minimum strength and, where a gap between substrates is to be filled, to span the distance between the substrates (possibly with the assistance of one or more blowing agents to make the adhesive body expand or foam when heated). Useful thicknesses have been found to be in the range of about 0.05 mm to about 25 mm or about 0.5 to about 5 mm, for example. The adhesive body need not be uniform in thickness.

The present invention may be practiced using any of a wide variety of substrates, including, for example, substrates comprised of metal, wood and other cellulosic materials, thermoset materials, plastics, glass, concrete, ceramics, stone, and the like. In one especially desirable aspect of the invention, the substrate is comprised of one or more metals such as steel, including galvanized steel, stainless steel, and cold rolled steel as well as aluminum. The surface of the metal substrate to which the adhesive body is to be applied may be bare, pretreated (conversion coated), primed, and/or painted.

Typically, one or more surfaces of the adhesive body are radiation cured after at least partially shaping or forming the adhesive body and before applying the adhesive body to the surface of the substrate desired to be sealed. For example, the adhesive composition may be formed into a relatively flat, thin sheet by extrusion or other suitable technique. The sheet is exposed on one side to radiation such as ultraviolet light to cure the surface of the sheet on that side (curing of the adhesive composition may extend part way into the adhesive layer, thereby forming a top layer that is radiation cured, with the epoxy resin component remaining uncured until the adhesive body is heated to a preselected activation temperature sufficient to initiate reaction of the curing agent). The sheet is then die cut or slit to provide the adhesive body, which is positioned onto the substrate surface in the desired location with the other side of the adhesive body that has not been cured by radiation being directed towards the substrate surface.

In one embodiment of the invention, a relatively thin skin is formed upon the surface of the adhesive body that has been exposed to radiation, as a result of the radiation-induced crosslinking or curing of at least certain components in the adhesive composition, e.g., the (meth)acrylate-functionalized oligomer(s) and/or monomer(s). The surface skin serves to stabilize the shape of the adhesive body, particularly when the adhesive body is heated to a temperature effective to soften or melt the portion of the adhesive composition in the adhesive body that remains thermoplastic and substantially non-crosslinked. The tear strength of the adhesive body can also be enhanced through the formation of such surface skin. Radiation-curing or hardening of the adhesive composition is typically controlled so as to extend only to a shallow depth within the adhesive body, it being understood that in at least some embodiments the curing is gradient in character (e.g., the adhesive composition is most fully cured by the radiation at the outermost surface, with the extent of curing becoming gradually less at successively deeper levels of the adhesive body).

Surface curing of the adhesive composition can be initiated using any suitable source of radiation, such as ultraviolet or electron beam radiation. Where the radiation source emits ultraviolet light, it will generally be desirable to include one or more photoinitiators in the adhesive composition. If electron beam radiation is utilized, the presence of a photoinitiator in the adhesive composition is generally not necessary.

One or more selected surfaces of the adhesive body are exposed to sufficient radiation in the form of ultraviolet light or electron beam radiation to cause reaction of the radiation-reactive components of the adhesive composition (e.g., the (meth)acrylate-functionalized oligomers and/or monomers) on the surface. At least a portion of the reactive components polymerize and/or cross-link so as to surface-harden or surface-cure the adhesive composition.

At the same time, the amount of radiation and the manner in which the adhesive body is exposed to the radiation are controlled so that at least one surface of the adhesive body (in particular, the adhesive body surface(s) to be applied to the substrate surface(s) desired to be sealed) remains substantially or completely uncured by the radiation. That is, the adhesive composition immediately proximate to such surface(s) does not cure or crosslink to a significant extent and thus remains more deformable than the surface(s) which has or have been radiation cured. As mentioned previously, the epoxy resin is generally not significantly reacted or cured by the radiation, thus leaving it available to be cured by heating to an elevated temperature effective to activate the curing agent.

The radiation-curable adhesive compositions utilized in the present invention can be cured using conventional techniques for radiation curing, such as irradiation of the composition layer on the substrate surface using UV (ultraviolet) light from low, medium and/or high pressure mercury vapor lamps, He—Cd and Ar lasers, tungsten filament lamps, xenon arc lamps, carbon arc lamps or other suitable source of radiation. The UV light may have a wavelength of from about 200 to about 450 nanometers. The source of the electron beams (highly accelerated electrons) can be a particle beam processing device. Such devices are well-known in the art and are described, for example, in published U.S. applications 2005-0233121, 2004-0089820, 2003-0235659, and 2003-0001108, each of which is incorporated herein by reference in its entirety. Suitable electron beam emitting devices are available, for example, from Energy Sciences, Inc.

The amount of radiation necessary to cure the adhesive body surface(s) to the desired extent will of course depend on the angle of exposure to the radiation, the thickness of the adhesive body, and the concentration and reactivity of the functional groups present in the radiation-reactive components of the adhesive composition. For example, an ultraviolet source with a wavelength between 200 and 300 nm (e.g. a filtered mercury arc lamp) or an electron beam source may be directed at a adhesive body carried on a conveyor system which provides a rate of passage past the radiation source appropriate for the radiation absorption profile of the adhesive composition (which profile is influenced by the degree and depth of surface cure desired and the rate of polymerization/crosslinking of the composition).

### Components of Adhesive Composition

### Epoxy Resins

In general, a large number of polyepoxides having at least about two 1,2-epoxy groups per molecule are suitable as epoxy resins for the adhesive compositions of this invention. The epoxy resins may be saturated, unsaturated, cyclic or acyclic, aliphatic, alicyclic, aromatic or heterocyclic polyepoxide compounds. Examples of suitable epoxy resins include the polyglycidyl ethers, which are prepared by reaction of epichlorohydrin or epibromohydrin with a polyphenol in the presence of alkali. Suitable polyphenols therefor are, for example, resorcinol, pyrocatechol, hydroquinone, bisphenol A(bis(4-hydroxyphenyl)-2,2-propane), bisphenol F(bis(4-hydroxyphenyl)methane), bis(4-hydroxyphenyl)-1,1-isobutane, 4,4′-dihydroxybenzophenone, bis(4-hydroxyphenyl)-1,1-ethane, and 1,5-hydroxynaphthalene. Other suitable polyphenols as the basis for the polyglycidyl ethers are the known condensation products of phenol and formaldehyde or acetaldehyde of the novolak resin-type.

Other epoxy resins that are in principle suitable are the polyglycidyl ethers of polyalcohols or diamines. Such polyglycidyl ethers are derived from polyalcohols, such as ethylene glycol, diethylene glycol, triethylene glycol, 1,2-propylene glycol, 1,4-butylene glycol, triethylene glycol, 1,5-pentanediol, 1,6-hexanediol or trimethylolpropane.

Other suitable epoxy resins include polyglycidyl esters of polycarboxylic acids, for example, reaction products of glycidol or epichlorohydrin with aliphatic or aromatic polycarboxylic acids, such as oxalic acid, succinic acid, glutaric acid, terephthalic acid or dimeric fatty acids.

Other epoxides are derived from the epoxidation products of olefinically-unsaturated cycloaliphatic compounds or from natural oils and fats (e.g., epoxidized castor oil).

Particular preference is given to the liquid epoxy resins derived by reaction of bisphenol A or bisphenol F and epichlorohydrin. The epoxy resins that are liquid at room temperature generally have epoxy equivalent weights of from 150 to about 480.

The epoxy resins that are solid at room temperature may also or alternatively be used and are likewise obtainable from polyphenols and epichliorohydrin; particular preference is given to those based on bisphenol A or bisphenol F having a melting point of from 45 to 130° C., preferably from 50 to 80° C. They differ from the liquid epoxy resins substantially by the higher molecular weight thereof, as a result of which they become solid at room temperature. The solid epoxy resins generally have an epoxy equivalent weight of ≧400.

Typically, the adhesive composition may contain from about 20 to about 55 weight percent (in one embodiment, from about 25 to about 50 weight percent) of epoxy resin (unless otherwise stated, all concentrations set forth herein are expressed in terms of the weight percent of the component in question based on the adhesive composition as a whole).

### Impact Modifiers/Toughening Agents

The impact properties of cured adhesives derived from the adhesive bodies of the present invention may often be improved by incorporating into the adhesive composition used to form the adhesive bodies one or more impact modifiers and/or toughening agents.

Suitable impact modifiers/toughening agents may be selected from a wide variety of substances, but generally speaking such materials are polymeric or oligomeric in character, have glass transition temperatures below 20° C. (more preferably below 0° C. or below −30° C. or below −50° C.), and have functional groups such as epoxy groups, carboxylic acid groups, amino groups and/or hydroxyl groups capable of reacting with the other components of the compositions of the present invention when the composition is cured by heating (although alternatively the impact modifiers/toughening agent may be free of such reactive functional groups).

The epoxy-based prepolymers (sometimes described herein as “adducts”) obtained by reacting one or more amine-terminated polymers such as amine-terminated polyethers and amino silane-terminated polymers with one or more epoxy resins represent a particularly preferred class of impact modifiers/toughening agents. The epoxy resins useful for such purpose may be selected from among the epoxy resins described hereinabove, with particular preference being given to the diglycidyl ethers of polyphenols such as bisphenol A and bisphenol F (for example, having epoxy equivalent weights of from about 150 to about 1000). Mixtures of solid and liquid epoxy resins may be suitably employed.

The preparation of such epoxy-based prepolymers from amine-terminated polyethers is well known in the art and is described, for example, in U.S. Pat. Nos. 5,084,532 and 6,015,865, each of which is incorporated herein by reference in its entirety. Generally speaking, it will often be desirable to adjust the ratio of amine-terminated polyether:epoxy resin being reacted such that there is an excess of epoxy groups relative to amine groups such that the latter functional groups are completely reacted (i.e., the epoxy-based prepolymer contains essentially no free amine groups).

Mixtures of di- and trifunctional amine-terminated polyethers may be used. Amine-terminated polyethers containing both oxyethylene and oxypropylene repeating units (e.g., copolymers of ethylene oxide and propylene oxide, with the copolymers having a block, capped or random structure) may also be utilized as the amino-terminated polyether. Preferably, the amino-terminated polyether contains at least two amine groups per molecule. Preferably, the amine groups are primary amine groups. The amino-terminated polyether is preferably aliphatic.

When reacting the epoxy resins with the amine-terminated polyether, an excess of epoxy groups over the amino groups is preferably used so that the latter react completely with epoxide groups. Typically, there is a 1.5 to 10-fold excess, for example a 3.5-fold excess of epoxy groups over the active hydrogen equivalents (AHEW) of the amine-terminated polyether. In preparing the adhesive composition used in the present invention, the epoxy-based prepolymer component preferably is initially prepared in a first stage. To this end, preferably, the epoxy resins are reacted with the amine-terminated polyether c) in the desired ratio. The reaction preferably is carried out at high temperature, preferably at 90 to 130° C., for example at approximately 120° C., for a duration of, e.g., three hours.

In the preparation of the epoxy-based prepolymer, the following compounds may, for example, be used:
1. linear amine-terminated polyoxyethylene ethers having the formula:

H₂N—(CH₂)₂—[O—(CH₂)₂—O—(CH₂)₂]ₙ—NH₂

in which n preferably is 17 to 27.
2. linear amine-terminated polyoxypropylene ethers having the formula:

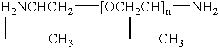

or isomers thereof, in which n preferably is 5 to 100. They are obtainable from Huntsman Chemical under the trade name JEFFAMINE® (D-series). The number average molecular weight of such amine-terminated polyoxypropylene ethers may vary, for example, from about 300 to about 5000.
3. trifunctional compounds having the formula:

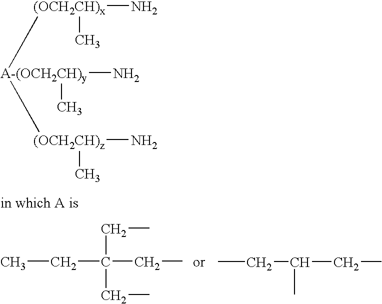

and x, y and z independently of each other are 1 to 40 and x+y+z is preferably >6. Representative examples of these trifunctional compounds are available commercially from Huntsman Chemical under the trade name Jeffamine® (T-series). Such substances typically have number average molecular weights of from about 300 to about 6000.
4. amino silane capped polymers, such as those that may be embraced by:

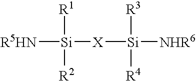

where R¹, R², R³ and R⁴ may be the same or different and are selected from hydrogen, hydroxyl, alkyl, alkoxy, alkenyl, alkenyloxy, aryl, and aryloxy; R⁵ and R⁶ may be the same or different and are selected from hydrogen, alkyl and aryl; and X is selected from alkylene, alkenylene, arylene, with or without interruption by a heteroatom; polyurethanes; polyethers; polyesters; polyacrylates; polyamides; polydienes; polysiloxanes; and polyimides.

For instance, amine-terminated siloxanes may be used, such as diamino siloxanes embraced by:

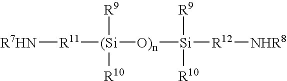

where R¹¹ and R¹² may be the same or different and are selected from alkylene, arylene, alkylene oxide, arylene oxide, alkylene esters, arylene esters, alkylene amides or arylene amides; R⁹ and R¹⁰ may be the same or different and are selected from alkyl or aryl; R⁷ and R⁸ are as defined above and n is 1-1,200.

In another particularly preferred embodiment of the invention, one or more polyurethanes (the term “polyurethanes” as used herein includes polyureas, polyurea-urethanes, as well as polyurethanes) are used as an impact modifier/toughening agent.

Polyurethanes suitable for use in the adhesive compositions of the present invention include the reaction products of isocyanate-terminated prepolymers and compounds having one or more active hydrogen-containing groups (e.g., hydroxyl, thiol and amino groups such as primary aliphatic, cycloaliphatic, heteroaromatic and araliphatic amino, secondary aliphatic, cycloaliphatic, heteroaromatic and araliphatic amino, alkyl amido, phenolic, benzyl alcohol, aminophenyl or benzylamino groups or the like, such as those described in U.S. Pat. Nos. 3,525,779; 3,636,133; 5,278,257; and 6,776,869; published U.S. application 2005-070634, and WO 2006/128722, each of which is incorporated herein by reference in its entirety). Such polyurethanes may or may not contain isocyanate-reactive end groups (e.g., active hydrogen-containing end groups). Polyurethanes of this type are also available commercially from Huntsman Advanced Materials (formerly Vantico) under the tradename RAM.

Particularly preferred polyurethanes include phenol-terminated polyurethanes, polyureas and polyurea-urethanes of the formula:

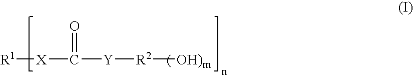

in which m is 1 or 2, n is 2 to 6, R¹ is the n-valent radical of an elastomeric prepolymer, after the removal of the terminal isocyanate, amino or hydroxyl groups, which is soluble or dispersible in epoxide resins (e.g., an amino-, thiol- or hydroxyl-terminated polyoxyalkylene such as polypropylene glycol or polytetrahydrofuran diol), X and Y independently of one another are —O— or —NR³—, it being necessary for at least one of these groups to be —NR³—, R² is an m+1-valent radical of a polyphenol or aminophenol after the removal of the phenolic hydroxy group(s) or the amino group or both the amino group and the phenolic hydroxyl group, respectively, and R³ is hydrogen, C1-C6 alkyl or phenol. Such polyurethanes are known in the art and are described, for example, in U.S. Pat. No. 5,278,257, incorporated herein by reference in its entirety. Epoxy resin adducts of such polyurethanes may also be utilized as the impact modifier/toughener in the present invention.

Another type of polyurethane found to be particularly effective as an impact modifier/toughener in the compositions of the present invention is represented by the following formula:

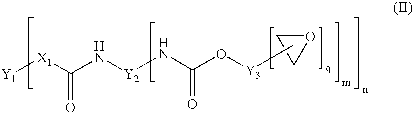

in which X₁ is O, S or NH; Y₁ is an n-valent radical of a reactive polymer (e.g., an amino-, thiol- or hydroxyl-terminated polyoxyalkylene such as polypropylene glycol or polytetrahydrofuran diol) after removal of the terminal amino, thiol or hydroxyl groups; Y₂ is a divalent radical of aliphatic, cycloaliphatic, aromatic or araliphatic diisocyanates after removal of the isocyanate groups or is a trivalent radical of trimers or biurets of aliphatic, cycloaliphatic, aromatic or araliphatic diisocyanates after removal of the isocyanate groups; Y₃ is a radical of an aliphatic, cycloaliphatic, aromatic or araliphatic epoxide containing a primary or secondary hydroxyl group after removal of the hydroxide and epoxide groups; q is 1, 2 or 3; m is 1 or 2; and n is 2, 3 or 4. Such polyurethanes are known in the art and are described, for example, in Canadian Pat. Application No. 2,510,486, incorporated herein by reference in its entirety.

Other tougheners or impact modifiers known in the epoxy adhesive art may be used in addition to, or as a substitute for, the aforementioned polyurethanes and epoxy-based prepolymers derived by reaction of amine-terminated polyethers or amino silane-terminated polymers with epoxy resins. Generally speaking, such tougheners and impact modifiers are characterized by having glass transition temperatures below about 0° C., preferably below about −30° C., even more preferably below about −50° C. Examples of such tougheners and impact modifiers include, but are not limited to:

rubber particles having a core-shell structure, having a core comprised of a polymeric material having elastomeric or rubbery properties (i.e., a glass transition temperature less than about 0° C., e.g., less than about −30° C.) surrounded by a shell comprised of a non-elastomeric polymeric material (i.e., a thermoplastic or thermoset/crosslinked polymer having a glass transition temperature greater than ambient temperatures, e.g., greater than about 50° C.), such as those described, for example, in WO 2007/025007, incorporated herein by reference in its entirety.
reaction products (adducts) of epoxy-reactive copolymers of butadiene (especially epoxy-reactive copolymers of butadiene with relatively polar comonomers such as (meth)acrylonitrile, (meth)acrylic acid, or alkyl acrylates, e.g., carboxyl-terminated butadiene-nitrile rubbers, such as the products available commercially from Noveon under the trade name HYCAR) with epoxy resins (as described, for example, in U.S. Patent Application Publication No. US 2003/0196753 and U.S. Pat. No. 6,776,869, each of which being incorporated herein by reference in its entirety);
adducts of athydrides (e.g., unsaturated anhydrides such as maleic anhydride)and diene polymers (e.g., liquid 1,4-cis polybutadienes), typically having number average molecular weights between about 1000 and about 5000, including for example, the adducts sold under the tradename POLYVEST by Degussa Corporation, as well as further reaction products of such adducts with epoxy resins;
polyesters, including, for example, amorphous, crystalline and/or semi-crystalline polyesters, including saturated polyesters, prepared by condensation of aliphatic and/or aromatic dicarboxylic acids (or the corresponding alkyl esters or anhydrides with diols having a chain length of C2 to C20, the polyesters being of medium molecular weight (e.g., about 1000 to about 20,000 number average molecular weight), such as the polyesters sold under the tradename DYNACOLL by Degussa Corporation, and including polyesters functionalized with carboxylic acid and/or hydroxyl endgroups, as well as adducts of such functionalized polyesters with epoxy resins;
adducts of dimeric fatty acids with epoxy resins (including, for example, the adducts sold under the tradename EPON 872 by Hexion Specialty Chemicals, the adducts sold under the tradename HYPOX DA323 (formerly ERISYS EMDA 3-23) by CVC Specialty Chemicals, as well as those adducts described in U.S. Pat. No. 5,218,063, incorporated herein by reference in its entirety);
adducts of hydroxyl-containing triglycerides (e.g., castor oil) with epoxy resins (including, for example, the adducts sold under the tradename HELOXY 505 by Hexion Specialty Chemicals);
adducts of polysulfides with epoxy resins (including, for example, the adducts sold under the tradename THIOPLAST EPS 350 by Akzo Nobel;
adducts of amine-terminated polydienes and diene copolymers with epoxy resins;
block copolymers, wherein at least one polymeric block of the copolymer has a glass transition temperature below 20° C. (preferably below 0° C. or below −30° C. or below −50° C.) such as a polybutadiene block or a polyisoprene block or hydrogenated derivative thereof and at least one polymeric block of the copolymer has a glass transition temperature above 20° C. (preferably above 50° C. or above 70° C.) such as a polystyrene block or a polymethylmethacrylate block, in particular block copolymers containing a polystyrene block, a 1,4-polybutadiene block (preferably having a glass transition temperature below about −60 degrees C.) and/or one or more polymethylmethacrylate blocks (preferably, having highly, i.e., >80%, syndiotactic structures), such as the SBM (styrene-butadiene-methylmethacrylate), MBM (methylmethacrylate-butadiene-methylmethacrylate) and BM (butadiene-methylmethacrylate) block copolymers made by living polymerization methods using nitroxide initiator (such as the methods described in U.S. Pat. Nos. 5,677,387, 5,686,534, and 5,886,112, each of which is incorporated herein by reference in its entirety) and sold under the tradename NANOSTRENGTH by Arkema and the block copolymers described in U.S. Pat. No. 6,894,113, incorporated herein by reference in its entirety;
carboxyl-functionalized adducts of amino- or hydroxyl-terminated polymers and carboxylic anhydrides, as well as further reaction products of such adducts with epoxy resins (such as those described in U.S. Pat. No. 6,884,854 and published U.S. application 2005-0215730, each of which is incorporated herein by reference in its entirety);
epoxy-terminated polyethers, such as polymers of alkylene oxides like ethylene oxide, propylene oxide or mixtures thereof that have been functionalized with epoxy groups, including by reacting the hydroxy groups of a polyalkylene glycol with epichlorohydrin;
phenol-terminated and aminophenyl-terminated products produced by reacting a stoichiometric excess of a carboxylic anhydride or dianhydride with a diamine or polyamine and then further reacting the excess carboxylic anhydride or carboxylic acid groups with at least one polyphenol or aminophenol, as described, for example, in published U.S. application 2004-0181013, incorporated herein by reference in its entirety.

Mixtures of different impact modifiers/toughening agents may be used. The amount of impact modifier/toughening agent in the adhesive composition used to form the adhesive body of the present invention may vary substantially but typically is from about 0.1 to about 40 weight percent, e.g. from about 5 to about 35 weight percent.

### Radiation Curable Compounds

The adhesive compositions used in the present invention comprise one or more radiation curable compounds, which may be monomeric or oligomeric in character. (Meth)acrylate-functionalized oligomers are particularly useful as the radiation curable compound. These are oligomeric substances of low to moderate molecular weight (e.g., from about 300 to about 10,000 number average molecular weight) having one or more acrylate and/or methacrylate groups attached to the oligomeric backbone. The (meth)acrylate (i.e., acrylate and/or methacrylate) functional groups may be in a terminal position on the oligomer and/or may be distributed along the oligomeric backbone. In one embodiment of the invention, at least a portion of the (meth)acrylated functionalized oligomers have two or more (meth)acrylate functional groups per molecule. Examples of such oligomers include (meth)acrylate-functionalized urethane oligomers (e.g., compounds obtainable by reacting a polyisocyanate or an isocyanate-functionalized polyurethane prepolymer with a compound containing both at least one (meth)acrylate group and at least one acidic hydrogen-containing functional group (such as a hydroxyl group)) such as (meth)acrylate-functionalized polyester urethanes and (meth)acrylate-functionalized polyether urethanes, (meth)acrylate-functionalized polyepoxide resins, (meth)acrylate-functionalized polybutadienes, (meth)acrylic polyol(meth)acrylates, polyester(meth)acrylate oligomers, polyamide(meth)acrylate oligomers, polyether(meth)acrylate oligomers and the like. Such (meth)acrylate-functionalized oligomers and their methods of preparation are disclosed in, for example, U.S. Pat. Nos. 4,574,138; 4,439,600; 4,380,613; 4,309,526; 4,295,909; 4,018,851, 3,676,398; 3,770,602; 4,072,529; 4,511,732; 3,700,643; 4,133,723; 4,188,455; 4,206,025; 5,002,976; and published U.S. applications 2004/0127594 and 2005/0065310. Such materials are available from numerous commercial sources, including the UVITHANE resins from Morton International, certain oligomers sold under the brand name PHOTOMER by Cognis Corporation, the CN oligomer resins from Sartomer Company, the GENOMER resins from Rahn Inc., and the EBECRYL resins from the Cytec Surface Specialties Division of Cytec Industries, Inc.

Suitable radiation-curable monomers which may be present in the adhesive composition include monomers having single (meth)acrylate groups such as tetrahydrofurfuryl(meth)acrylate, hydroxyethyl(meth)acrylate, hydroxypropyl(meth)acrylate, isobornyl(meth)acrylate, methyl(meth)acrylate, ethyl(meth)acrylate, isopropyl(meth)acrylate, isooctyl(meth)acrylate, octyl(meth)acrylate, decyl(meth)acrylate, (meth)acrylic acid, n-hexyl(meth)acrylate, stearyl(meth)acrylate, allyl(meth)acrylate, 2(2-ethoxyethoxy)ethyl(meth)acrylate, 2-phenoxyethyl(meth)acrylate, ethoxylated nonyl phenol(meth)acrylates, (meth)acrylated monomers such as those described in U.S. Pat. No. 4,652,274, monomethoxy tripropylene glycol monoacrylate (available from Cognis Corporation under the designation PHOTOMER 8061), neopentylglycol propoxylate (2) methylether monoacrylate (available from Cognis Corporation under the designation PHOTOMER 8127), and the like. Other suitable (meth)acrylate-functionalized monomers include carboxylic acid-functionalized ester-containing (meth)acrylate monomers, e.g., compounds containing at least one carboxylic acid group (—CO₂H), at least one ester linkage (in addition to at least one acrylate or methacrylate group) and at least one acrylate or methacrylate group per molecule. Such substances are well-known in the art and may be prepared using any suitable synthetic method. For example, one such method involves reacting a compound containing both a hydroxyl group and a (meth)acrylate group with an anhydride. Carboxylic acid-functionalized ester-containing (meth)acrylate monomers suitable for use in the present invention are available from commercial sources, including, for example, ECX 4046 from Cognis Corporation and the series of specialty oligomers sold by the Sartomer Company under the brand name SARBOX.

Suitable monomers having plural (meth)acrylate functionality (i.e., two or more (meth)acrylate groups per molecule) include, for example, 1,3-butylene glycol di(meth)acrylate, diethylene glycol di(meth)acrylate, 1,6-hexanediol di(meth)acrylate, neopentyl glycol di(meth)acrylate, triethylene glycol di(meth)acrylate, tetraethylene glycol di(meth)acrylate, dipropylene glycol di(meth)acrylate, tripropylene glycol di(meth)acrylate, trimethylol propane ethoxylate tri(meth)acrylate, pentaerythritol tetra(meth)acrylate, tripropylene glycol di(meth)acrylate, trimethylol propane tri(meth)acrylate, ethoxylated bisphenol A di(meth)acrylates, ethoxylated hexanediol di(meth)acrylates, tris(2-hydroxyethyl) isocyanurate tri(meth)acrylate, ditrimethylol propane tetra(meth)acrylate, dipentaerythritol penta(meth)acrylate, propoxylated glycerol tri(meth)acrylates, pentaerythritol tri(meth)acrylate, and the like. In one embodiment of the invention, the adhesive composition may be comprised of one or more alkoxylated polyol poly(meth)acrylates containing at least three (meth)acrylate groups per molecule. The polyol may be an organic compound containing three or more hydroxyl groups trimethylolethane, trimethylolpropane, pentaerythritol, dipentaerythritol, sugar alcohols, or the like. The polyol is reacted with one or more alkylene oxides such as ethylene oxide or propylene oxide (typically, from about 1 to about 20 moles of alkylene oxide per mole of polyol) to form an alkoxylated polyol, then esterified with acrylic acid, methacrylic acid, or a derivative thereof to obtain the alkoxylated polyol poly(meth)acrylate.

Epoxy(meth)acrylates, including aromatic and aliphatic epoxy(meth)acrylates, are another class of radiation-curable compounds suitable for use in the adhesive compositions of the present invention. Epoxy(meth)acrylates are the beta-hydroxy esters which are generated by the reaction of acrylic acid and/or methacrylic acid (or an equivalent thereof, such as an anhydride) with an epoxy compound, preferably an epoxy compound having an epoxy functionality of two or greater. Suitable epoxy(meth)acrylates include the relatively low viscosity epoxy(meth)acrylates derived from diglycidyl ethers obtained by reaction of epichlorohydrin with an aliphatic alcohol containing two or more hydroxyl groups per molecule. Suitable aliphatic alcohols include, for example, glycols such as ethylene glycol, 1,2-propanediol, 1,3-propanediol, 1,2-butanediol, 1,4-butanediol, 1,6-hexanediol, neopentyl glycol and other linear and branched C2-C10 aliphatic diols, triols such as glycerin, trimethyolpropane, trimethylolethane, butanetriols, pentanetriols, and the like, tetrols such as pentaerythritol, as well as other polyfunctional alcohols such as dipentaerythritol, sugar alcohols and the like and alkoxylated derivatives thereof (where the alcohol has been reacted with an alkylene oxide such as ethylene oxide or propylene oxide, including both oligomeric species such as diethylene glycol or tripropylene glycol as well as polymeric species such as polyethylene glycols or polypropylene glycols or block, capped or random copolymers of ethylene oxide and propylene oxide). The alcohol may also be an aromatic alcohol such as bisphenol A, bisphenol F, or the like. The epoxy compound reacted with the (meth)acrylic acid may also be an epoxidized unsaturated triglyceride such as epoxidized soybean oil or epoxidized linseed oil. Preferably, all or essentially all of the epoxy groups on the epoxy compound are ring-opened with the (meth)acrylic acid. Suitable preferred epoxy(meth)acrylates thus have two, three, or more (meth)acrylate groups and two, three, or more hydroxyl groups per molecule. Specific illustrative examples of suitable epoxy compounds include bisphenol A diglycidyl ethers, bisphenol F diglycidyl ethers, hexanediol diglycidyl ethers, neopentyl glycol diglycidyl ethers, and butanediol diglycidyl ethers.

The adhesive composition should contain sufficient radiation curable compound (e.g., (meth)acrylate-functionalized oligomer and/or monomer) to allow a selected surface of the adhesive body prepared therefrom to be crosslinked/cured by radiation to the desired extent. Such amount will vary depending upon the particular radiation curable compound(s) selected, but typically will be at least about 0.5 weight percent but no greater than about 30 weight percent (e.g., 1-10 weight percent).

### Curing Agents

Since the adhesive compositions used to prepare the adhesive bodies of the present invention are one-part or single-component compositions and are to be cured at elevated temperature, they also contain one or more curing agents (hardeners) capable of accomplishing cross-linking or curing of certain of the adhesive body components (in particular, the epoxy resin or resins) when the adhesive body is heated to a temperature well in excess of room temperature. That is, the hardener is activated by heating. The hardener may function in a catalytic manner or, in preferred embodiments of the invention, participate directly in the curing process by reaction with one or more of the adhesive components.

There may be used as thermally-activatable or latent hardeners for the adhesive compositions, for example, guanidines, substituted guanidines, substituted ureas, melamine resins, guanamine derivatives, cyclic tertiary amines, aromatic amines and/or mixtures thereof. The hardeners may be involved stoichiometrically in the hardening reaction; they may, however, also be catalytically active. Examples of substituted guanidines are methyl-guanidine, dimethylguanidine, trimethylguanidine, tetramethylguanidine, methylisobiguanidine, dimethylisobiguanidine, tetramethylisobiguanidine, hexamethylisobiguanidine, heptamethylisobiguanidine and, more especially, cyanoguanidine(dicyandiamide). Representatives of suitable guanamine derivatives which may be mentioned are alkylated benzoguanamine resins, benzoguanamine resins or methoxymethylethoxymethylbenzoguanamine. For single-component, thermosetting adhesives, the selection criterion is, of course, the low solubility of those substances at room temperature in the epoxy resin component, so that solid, finely ground hardeners are preferred; dicyandiamide is especially suitable. Good storage stability of the adhesive body is thereby ensured.

In addition to or instead of the above-mentioned hardeners, catalytically-active substituted ureas may be used. They are especially p-chlorophenyl-N,N-dimethylurea(monuron), 3-phenyl-1,1-dimethylurea(fenuron) or 3,4-dichlorophenyl-N,N-dimethylurea(diuron). In principle, catalytically active tertiary acryl- or alkyl-amines, such as benzyldimethylamine, tris(dimethylamino)phenol, piperidine or piperidine derivatives, may also be used, but they are in many cases too highly soluble in the adhesive composition, so that usable storage stability of the adhesive body is not achieved. Various imidazole derivatives, preferably solid imidazole derivatives, may also be used as catalytically-active accelerators. Examples which may be mentioned are 2-ethyl-2-methylimidazole, N-butylimidazole, benzimidazole and N—C₁ to C₁₂-alkylimidazoles or N-arylimidazoles. Particular preference is given to the use of a combination of hardener and accelerator in the form of so-called accelerated dicyandiamides in finely ground form. The separate addition of catalytically-active accelerators to the adhesive composition is thus not necessary.

The amount of curing agent utilized will depend upon a number of factors, including whether the curing agent acts as a catalyst or participates directly in crosslinking of the adhesive composition, the concentration of epoxy groups and other reactive groups in the composition, the desired curing rate and so forth. Typically, the adhesive composition contains from about 0.5 to about 8 weight percent curing agent(s).

### Expanding Agents/Blowing Agents

In one embodiment of the invention, the adhesive composition used to prepare the adhesive body additionally contains one or more expanding agents (sometimes referred to in the art as blowing agents). The expandable properties of the resulting adhesive are particularly useful in applications where the complete filling of a gap between substrates is critical in order to maintain maximum structural integrity of the assembly obtained thereby. The expanding agent is preferably a latent expanding agent that causes expansion or foaming of the adhesive body only when heated to a temperature significantly above room temperature (typically, a temperature which is in the range at which thermal curing of the adhesive is also initiated). Although any suitable expanding agent may be employed, such as a chemical expanding agent, e.g., azo compounds, hydrazides and the like, particular preference is given to expandable microspheres. Expandable microspheres generally comprise small diameter polymeric shells or bubbles which encapsulate one or more volatile substances such as light hydrocarbons or halocarbons. The outer shells are usually thermoplastic in character to permit softening and expansion of the microspheres when heated due to volatilization of the substances trapped within the shells. The polymers used in the shells may be linear, branched, or cross-linked and may be comprised of, for example, acrylic resins, styrenic resins, polyvinylidene chloride, nitrile polymers, and the like. Typically, the average particle size of the expandable microspheres is in the range of from about 5 to about 100 microns. Suitable expandable microspheres are commercially available under the brand names DUALITE and EXPANCEL from Henkel Corporation (formerly, Pierce & Stevens) and Casco Nobel, respectively.

### Fillers

In certain embodiments of the invention, the adhesive composition contains one or more fillers, especially inorganic fillers in finely divided (powdered) form. The incorporation of fillers may be used to control certain characteristics of the adhesive composition and the adhesive bodies produced therefrom, including, for example, the Theological properties (both in the solid state and when the adhesive composition is melted or softened), density, flame resistance, cost, mechanical strength and the like. Examples of suitable fillers include talc, ground and precipitated chalks, silica, titanium dioxide, magnesium carbonate, calcium oxide, barium sulfate, calcium carbonate, calcium-magnesium carbonates, alumina, zirconia, zinc oxides, and other inorganic metal oxides, sulfides, sulfates and carbonates, clays, zeolites, glass beads (including hollow glass microspheres), glass fibers, polymeric fibers, ground or powdered metals (e.g., pure metals and/or alloys such as aluminium, steel, iron, zinc), mica, carbon black, barite and silicate fillers of the aluminium-magnesium-calcium type, such as wollastonite and chlorite. Although no filler need be present, typically the adhesive composition may contain from about 1 to about 60 weight percent of one or more fillers.

### Photoinitiators

Where the adhesive composition is to be cured using ultraviolet radiation, the composition additionally preferably contains at least one photoinitiator, which may be employed alone or in combination with a photosensitizer. Suitable photoinitiators are any of those known to those skilled in the art for use with radiation (including visible and ultraviolet light) curable (meth)acrylate systems. Exemplary of such photoinitiators are acetophenone and its derivatives such as dichloroacetophenone, trichloroacetophenone, dialkoxyacetophenone, 2,2-dimethoxy-2-phenylacetophenone and 4-dialkylaminoacetophenone; benzophenone and its derivatives such as 4,4′-bis(dimethylamino)benzophenone (Michler's ketone) and 4,4′-bis(diethylamine)benzophenone; benzil; benzoin and its derivatives such as benzoin alkyl ether; benzildimethylketal; benzoylbenzoate; alphaacyloxime esters; thioxanthone and its derivatives such as 2-chlorothioxanthone and diethylthioxanthone; azo-compounds such as azobisisobutyronitrile; benzoyl peroxide; camphoquinone; phosphine oxides such as diphenyl-2,4,6-trimetbylbenzoylphosphine oxide and the like. Especially preferred photoinitiators include aryl-substituted ketones and benzoyl-substituted phosphine oxides. Examples of commercially available photoinitiators suitable for use in the present invention include DAROCUR 1173, DAROCUR 4265, IRGACURE 651, IRGACURE 2959, and IRGACURE 819. The precise concentration of photoinitiator(s) in the adhesive composition is not believed to be particularly critical, although a sufficient amount should be used to effectively accomplish curing of the radiation curable compound(s) within the desired period of time upon exposing the composition to light radiation. Typically, photoinitiator concentrations of from about 0.01 to about 5 weight percent (e.g., about 0.1 to about 2 weight percent) are utilized.

### Other Additives

The adhesive compositions according to the present invention may also contain other common adjuvants and additives, such as plasticizers, reactive and/or non-reactive diluents, flow auxiliarlies, coupling agents (e.g., silanes), processing aids, wetting agents, tackifiers, flame retardants, adhesion promoters, thixotropic and/or rheology control agents (e.g., fumed silica, mixed mineral thixotropes), thickeners, ageing and/or corrosion inhibitors, anti-oxidants, stabilizers and/or pigments.

In one embodiment, the composition includes a reactive diluent such as a mono-epoxide (e.g., monoglycidyl ethers of alkyl- and alkenyl-substituted phenols). Typically, the composition may contain up to 15 weight percent (e.g., from about 0.5 to about 10 weight percent) reactive diluent.

Radiation absorbers or blocking agents may be incorporated into the adhesive composition for the purpose of limiting the depth of radiation cure in the adhesive body, e.g., controlling such curing so that substantially only the adhesive composition on and immediately proximate to the selected surface is fully cured.

In one aspect of the invention, the adhesive composition is free or essentially free of any volatile organic compounds (VOCs) such as solvents and the like.

### Illustrative Formulations for Adhesive Composition

Adhesive compositions useful for preparing preformed adhesive bodies in accordance with the present invention may correspond to the following illustrative formulations, where the amounts listed are expressed as weight percent based on the total weight of the adhesive composition (it being understood that the formulation may contain one or more additional ingredients in combination with the components listed below):

20-60 wt. % epoxy resin(s) (in particular, diglycidyl ethers of polyphenols such as bisphenol A);

10-60 wt. % toughening agent(s)/impact modifier(s);

1-10 wt. % curing agent(s)/accelerator(s);

5-60 wt. % filler(s)/thixotropic agent(s);

0.5-10 wt. % radiation-curable compound(s);

0.1-3 wt. % photoinitiator(s) (if the adhesive composition is to be cured using ultraviolet light).

In preferred embodiments of the invention, the adhesive composition is formulated such that an adhesive body prepared therefrom is dimensionally stable at room temperature (e.g., 15 to 25 degrees C.), even before being subjected to irradiation. “Dimensionally stable” in the context of the present invention means that the adhesive body retains its desired dimensions in the absence of any forces other than gravity, i.e., the adhesive body does not flow, spread, or distort when placed on a surface.

### Methods of Use

The inventive adhesive bodies are suitable for adhering together parts made of a variety of different materials, including, for example, wood, metal, coated or pretreated metal, plastic, filled plastic, thermoset materials such as sheet molding compound and fiberglass and the like. The substrates to be joined using the adhesive bodies may be the same as or different from each other. The present invention is preferably used for the gluing of metal parts and particularly for the gluing of steel sheets such as cold rolled steel sheets. These can also be electro-galvanized, hot-dip galvanized, galvannealed and/or zinc/nickel-coated steel sheets, for example.

The inventive adhesive body can be applied to a substrate surface by any technique known in the art. For example, it can be applied by a robot onto the substrate, or by mechanical application methods, or simply pressed into place by hand. Generally, the adhesive body (bodies) is (are) applied to one or both of the substrates to be joined. The substrates are arranged such that the adhesive body (bodies) is (are) located between the substrates to be bonded together. Where the adhesive composition is non-expandable (i.e., does not contain a blowing agent), it will generally be desirable to contact both sides of the adhesive body with a substrate surface (e.g., forming a sandwich-type structure). Where the adhesive composition is expandable, it is also possible to leave a gap between a surface of the adhesive body and a substrate surface, as the adhesive body when heated will expand in volume and close such gap. After positioning the adhesive body (bodies) is this manner, the adhesive body (bodies) is (are) subjected to heating to a temperature at which the beat activatable or latent curing agent initiates cure of the epoxy resin in the adhesive body (bodies).

The adhesive body is preferably finally cured in an oven at a temperature which lies clearly at or above the temperature at which the curing agent and/or latent expanding agent (if present) are activated (i.e., in the case of the hardener, the minimum temperature at which the curing agent becomes reactive towards the other components of the adhesive; in the case of the expanding agent, the minimum temperature at which the expanding agent causes foaming or expansion of the adhesive body). Curing preferably takes place at a temperature above 150° C., for example at 160 to 190° C., for about 10 to about 60 minutes.

One particularly preferred application for the adhesive bodies according to the present invention is the formation of structural bonds in vehicle construction.

As previously mentioned, in a particularly preferred embodiment of the invention the adhesive composition is comprised of at least one epoxy resin (in particular, at least one polyglycidyl ether of a polyphenol), at least one (meth)acrylate-functionalized monomer or oligomer, at least one heat-activated curing agent and at least one filler. Optionally, the adhesive composition may contain additional components such as thixotropic agents, pigments, photoinitiators, and other additives. Such compositions may desirably be formulated so as to be radiation-curable, thermoplastic (substantially solid or non-flowing at room temperature, but capable of melting or softening or otherwise rendered moldable to at least some extent when heated up to a certain temperature), as well as heat-curable once heated past a certain temperature and/or for a certain period of time. In one embodiment, the surface of the adhesive composition is tacky at room temperature but following exposure to an amount of radiation effective to achieve at least partial curing of the surface becomes reduced in tackiness or even entirely non-tacky at room temperature. Preferably, the melting or softening point of the non-irradiated adhesive composition is at least 50 degrees C. In one embodiment, the components of the adhesive composition are selected such that the composition remains thermoplastic within the temperature range of from about 60 degrees C. to about 100 degrees C., but then becomes thermoset (thermally crosslinked) when heated to a higher temperature (e.g., from about 120 degrees C. to about 200 degrees C.).

### EXAMPLES

### Example 1 (Comparative)

An adhesive composition was prepared using the following components, with the amount of each component being expressed in parts by weight:

| | |
|---|---|
| EPON 828 epoxy resin¹ | 190 |
| EPON 1001F epoxy resin² | 170 |
| EPI-REZ 58005 epoxy resin adduct³ | 240 |
| HYPOX RK 84 epoxy resin adduct⁴ | 80 |
| AEROSIL R202 thixotropic agent⁵ | 32 |
| Wollastonite filler | 80 |
| AMICURE CG1200 curing agent⁶ | 64 |
| OMICURE U-52 accelerator⁷ | 1.6 |
| Carbon black pigment | 0.8 |
| Total | 858.4 |

¹Liquid diglycidyl ether of bisphenol A having an epoxide equivalent weight of 185-192; supplied by Hexion Specialty Chemicals
²Solid diglycidyl ether of bisphenol A having an epoxide equivalent weight of 525-550; supplied by Hexion Specialty Chemicals
³Adduct of carboxy-terminated butadiene/acrylonitrile copolymer containing ca. 40 wt. % elastomer and having an epoxide equivalent weight of 325-375; supplied by Hexion Specialty Chemicals
⁴Adduct of carboxy-terminated butadiene/acrylonitrile copolymer containing ca. 32 wt. % elastomer and having an epoxide equivalent weight of 1200-1800; supplied by CVC Specialty Chemicals, Inc.
⁵hydrophobic fumed silica; supplied by Degussa Corporation
⁶dicyandiamide; supplied by Air Products & Chemicals
⁷aromatic substituted urea; supplied by CVC Specialty Chemicals, Inc.

### Example 2 (Invention)

An adhesive composition in accordance with the invention was prepared using the same components in the same amounts as in Example 1, with the adhesive composition additionally containing 9 parts by weight DAROCURE 1173 photoinitiator and 20 parts by weight CN 110 UV curable oligomer supplied by Sartomer (total=887.4 parts by weight).

### Example 3 (Invention)

An adhesive composition in accordance with the invention was prepared using the same components in the same amounts as in Example 2, with the adhesive composition additionally containing 20 parts by weight trimethylolpropane trimethacrylate.

Adhesive bodies were formed using the adhesive compositions of Examples 2 and 3. The adhesive bodies were cured on one surface in one pass using a LOCTITE brand UV machine and the following conditions: light source to surface=4.5 inches; belt speed=3 ft/minute; B bulb; UV A=1.341 W/cm² intensity, 7.395 J/cm² energy; UV B=0.373 W/cm² intensity, 2.141 J/cm² energy; UV C=0.045 W/cm² intensity, 0.29 J/cm² energy; UV V=0.633 W/cm² intensity, 3.694 J/cm² energy; UV total=13.52 J/cm² energy. The adhesive body surfaces that had been exposed to the ultraviolet radiation were essentially non-tacky at room temperature, with the adhesive body of Example 3 exhibiting a somewhat higher degree of surface cure than the adhesive body of Example 2.

The overlap shear strength of the adhesive bodies, both with and without preliminary surface curing using ultraviolet radiation, was measured in accordance with SAE J1523 (0.13 or 0.8 bondline; baked 10 minutes at a metal temperature of 340 degrees F; 25.4×12.5 mm overlap; 13 mm/min pull rate; normal at 23 degrees C.; average of three samples). The results measured are shown in Table 1 (the values listed are in MPa).

TABLE 1

| | Example | Example |
|---|---|---|
| | 2 (No UV | 3 (No UV |
| Substrates/Bondline | Cure/UV Cure) | Cure/UV Cure) |
| Cold Rolled Steel | 20.5/21.0 | 21.0/20.7 |
| (0.13 mm bondline) | | |
| Cold Rolled Steel | 11.9/11.8 | 12.6/10.9 |
| (0.8 mm bondline) | | |
| Electrogalvanized | 14.6/16.0 | 12.8/16.4 |
| Steel (0.13 mm bondline) | | |
| Electrogalvanized | 11.9/11.2 | 10.3/7.0 |
| Steel (0.8 mm bondline) | | |

Surprisingly, little or no difference in overlap shear strength was observed between the radiated and non-radiated adhesive bodies. However, the adhesive bodies that had been surface cured through exposure to ultraviolet light were much easier to handle due to their non-tacky outer surface and greater resistance to deformation prior to heat curing.

What is claimed is:

1. A method of joining a first substrate with a second substrate, said method comprising:
a). providing an adhesive composition comprised of at least one epoxy resin, at least one heat-activatable curing agent, and at least one radiation-curable compound;
b). forming said adhesive composition into an adhesive body having a preselected shape, said preselected shape having at least a first surface and a second surface;
c). exposing said first surface to an amount of radiation effective to cure at least a portion of the at least one radiation-curable compound present in proximity to said first surface, thereby rendering said first surface less tacky and/or more resistant to deformation;
d). applying the second surface of the adhesive body to a surface of said first substrate;
e). positioning a surface of said second substrate proximate to or in contact with said first surface of said adhesive body; and
f). heating said adhesive body to a temperature effective to activate said heat-activated curing agent and induce curing of said at least one epoxy resin, thereby forming an adhesive bond between said first substrate and said second substrate.

2. The method of claim 1, wherein said second surface of said adhesive body is in contact with a protective sheet, with said protective sheet being removed from said adhesive body after step c) and before step d).

3. The method of claim 2, wherein said protective sheet is a release film or paper.

4. The method of claim 1, wherein said preselected shape is an elongated strip.

5. The method of claim 1, wherein said second surface of said adhesive body is tacky.

6. The method of claim 1, wherein said second surface of said adhesive body is sufficiently tacky at room temperature to permit said second surface to adhere to said surface of said first substrate without the use of mechanical fastening means.

7. The method of claim 1, wherein both said first substrate and said second substrate are metallic.

8. The method of claim 1, wherein said adhesive composition comprises at least one glycidyl ether of a polyphenol.

9. The method of claim 1, wherein said adhesive composition additionally comprises at least one heat-activatable blowing agent.

10. The method of claim 1, wherein said adhesive composition comprises at least one (meth)acrylate-functionalized compound.

11. The method of claim 1, wherein said adhesive composition additionally comprises at least one photoinitiator.

12. The method of claim 1, wherein said radiation is ultraviolet light.

13. The method of claim 1, wherein said adhesive composition comprises at least one (meth)acrylate-functionalized oligomer.

14. The method of claim 1, wherein said first surface is tacky before step c) and non-tacky after step c).

15. A method of making an adhesive body, said method comprising:
a). providing an adhesive composition comprised of at least one epoxy resin, at least one heat-activatable curing agent, and at least one radiation-curable compound;
b). forming said adhesive composition into an adhesive body having a preselected shape, said preselected shape having at least a first surface and a second surface, wherein said second surface is in contact with a protective sheet; and
c). exposing said first surface to an amount of radiation effective to cure at least a portion of the at least one radiation-curable compound present in proximity to said first surface, thereby rendering said first surface less tacky and/or more resistant to deformation.

16. An article comprising an adhesive body in combination with a protective sheet, wherein
a). said adhesive body has a preselected shape and is comprised of at least one epoxy resin, at least one heat-activatable curing agent, and at least one radiation-curable compound, said preselected shape having at least a first surface and a second surface, b). said second surface is in contact with said protective sheet; and c). at least a portion of said first surface has been exposed to an amount of radiation effective to at least partially cure said at least one radiation-curable compound.

17. An assembly comprising a first substrate and a second substrate, wherein said first substrate and said second substrate have been joined using the method of claim 1.

18. A method of joining a first substrate with a second substrate, said method comprising:
a). applying an adhesive body to a surface of said first substrate, wherein said adhesive body has a preselected shape having at least a first surface and a second surface and is formed from an adhesive composition comprised of at least one epoxy resin, at least one heat-activatable curing agent, and at least one radiation-curable compound, wherein said first surface of said adhesive body has been exposed to an amount of radiation effective to cure at least a portion of the at least one radiation-curable compound present in proximity to said first surface, thereby rendering said first surface less tacky and/or more resistant to deformation, and wherein said second surface of said adhesive body is placed in contact with said surface of said first substrate;
b). positioning a surface of said second substrate proximate to or in contact with said first surface of said adhesive body; and
c). heating said adhesive body to a temperature effective to activate said heat-activated curing agent and induce curing of said at least one epoxy resin, thereby forming an adhesive bond between said first substrate and said second substrate.
